(19) United States
(12) Patent Application Publication
(10) Pub. No.: US 2012/0318421 A1
(43) Pub. Date: Dec. 20, 2012

(54) NON-PNEUMATIC TIRE TIRE/WHEEL ASSEMBLY

(75) Inventors: Jun Matsuda, Hiratsuka-shi (JP); Yasunobu Seki, Hiratsuka-shi (JP); Keisuke Chino, Hiratsuka-shi (JP); Yoshiaki Hashimura, Hiratsuka-shi (JP)

(73) Assignee: The Yokohama Rubber Co., LTD., Tokyo (JP)

(21) Appl. No.: 13/522,765

(22) PCT Filed: Oct. 15, 2010
(86) PCT No.: PCT/JP2010/068174

§ 371 Date: Jul. 18, 2012

(30) Foreign Application Priority Data
Jan. 18, 2010 (JP) 2010-007941

(51) Int. Cl. B60C 7/24

(52) U.S. Cl. 152/323

(57) ABSTRACT

A non-pneumatic tire tire/wheel assembly including a tire main body 1 at least a part of which is constituted by an elastomer composition, the tire main body being assembled on a wheel. The tire main body 1 is tightened and fixed to the wheel by a tightening member 7 that is embedded in the tire main body 1 throughout a tire circumferential direction. Furthermore, at least a part of the elastomer composition constituting the tire main body is a thermoreversible crosslinking elastomer composition. In the non-pneumatic tire tire/wheel assembly for light vehicle use, a tire/wheel assembly can be provided in which a tire is strongly and reliably fixed to a wheel and, moreover, by which recycling (material recycling) of the tire main body is enabled.

### TECHNICAL FIELD

The present technology relates to a non-pneumatic tire tire/wheel assembly and particularly to a tire/wheel assembly that is optimal as a non-pneumatic tire tire/wheel assembly for use on a light vehicle such as a bicycle, a wheelchair, a golf cart, and the like.

More specifically, the present technology relates to a non-pneumatic tire tire/wheel assembly for light vehicle use in which a tire main body does not separate from a wheel even when used under severe conditions over an extended period of time and, moreover, that has superior material recyclability.

### BACKGROUND

In general, pneumatic tires have been used as tires for use on light vehicles such as bicycles, wheelchairs, golf carts, and the like. However, in recent years, non-pneumatic tires have been proposed, particularly because of merits such as being punctureless and the like, and such non-pneumatic tires have been implemented to a certain degree.

These non-pneumatic tires are generally known as solid tires. For example, as illustrated in the partial cross-sectional perspective view of FIG. 7-1, a tire main body 1 is constituted by a circular body having a solid structure formed from a rubber material or the like. Groove portions 2 are formed throughout a circumference of the tire on both sides of the tire main body 1 and, as illustrated in FIG. 7-2, a tire/wheel assembly is formed by mating the groove portions 2 with a rim of a wheel 4. Moreover, as necessary, tread grooves 3 are formed in a tread surface 5.

Additionally, a non-pneumatic tire for use on bicycles, wheelchairs, vehicles and the like has been proposed in which, particularly, the tire main body 1 is provided with a hollow structure in order to obtain a reduction in overall weight of the tire and shock absorption effects (see Japanese Unexamined Patent Application Publication No. 2003-226105A).

In these conventionally proposed non-pneumatic tire tire/wheel assemblies for light vehicle use, fixing the tire main body 1 to the wheel 4 is generally performed only by mating the groove portions 2 provided on side surfaces of the tire main body 1 with the rim of the wheel 4, in a state where the tire main body 1 is pressed into the wheel 4.

However, the overall weight of bicycles, wheelchairs, and other vehicles belonging to the light vehicle category is light and, therefore such vehicles, in some cases, are subjected to sudden turning, moving while sliding the tire laterally, and the like. In such cases, with the conventional assembly/fixing method of the tire/wheel assembly, there is a problem in that the tire main body is prone to separation from the rim (wheel).

In order to eliminate such separation of the tire main body from the rim to the greatest extent possible, means, for example, by which the tire main body and the rim are adhered/fixed using an adhesive material or the like are conceivable, but if the tire main body is adhered/fixed to the rim, workability when removing the tire main body from the wheel in order to replace the tire main body or the like will be poor and, as a result, implementation of such means has been difficult.

### SUMMARY

### Problem to be Solved by the Technology

In light of the problems described above, an object of the present technology is to provide anon-pneumatic tire tire/wheel assembly for light vehicle use, whereby a tire is strongly and reliably fixed to a wheel.

Another object is to provide a non-pneumatic tire tire/wheel assembly by which recycling (material recycling) of the tire main body of the tire/wheel assembly of the present technology is enabled.

### Means of Solving the Problem

A non-pneumatic tire tire/wheel assembly of the present technology by which the objects described above are achieved has the following configuration.

(1) A non-pneumatic tire tire/wheel assembly including a tire main body at least a part of which is constituted by an elastomer composition, the tire main body being assembled on a wheel, wherein the tire main body is tightened and fixed to the wheel by a tightening member that is embedded in the tire main body throughout a tire circumferential direction.

Additionally, the non-pneumatic tire tire/wheel assembly of the present technology preferably includes any one of the configurations described in (2) to (14) below.

Particularly, non-pneumatic tire tire/wheel assemblies of any one of (10) to (13) below enable the material recyclability of the tire main body and are preferable from the standpoint of global environmental preservation.

(2) The non-pneumatic tire tire/wheel assembly described in (1), wherein the tightening member embedded in the tire main body is disposed inside a hollow hole machined in the tire main body in the tire circumferential direction, and the tire main body has a tightening member through-hole communicating with the hollow hole and open to an outer surface of the tire main body.

(3) The non-pneumatic tire tire/wheel assembly described in (2), wherein the tightening member embedded in the tire main body is exposed at at least one location on a tire circumference via the tightening member through-hole communicating with the hollow hole and open to the outer surface of the tire main body, and both end portions of the tightening member are fastened at the exposed portion.

(4) The non-pneumatic tire tire/wheel assembly described in (2), wherein the tightening member through-hole communicating with the hollow hole opens more to a tread surface side than a center axis position of the hollow hole in a tire radial direction.

(5) The non-pneumatic tire tire/wheel assembly described in (4), wherein the tightening member through-hole communicating with the hollow hole opens to the tread surface.

(6) The non-pneumatic tire tire/wheel assembly described in (5), wherein the tightening member through-hole is disposed at a location where the opening overlaps with a tire equatorial plane, and opens to the tread surface.

(7) The non-pneumatic tire tire/wheel assembly described in any one of (4) to (6), wherein the tightening member through-hole is filled with a thermoplastic elastomer composition or a thermoreversible crosslinking elastomer composition after the tire main body is tightened and fixed to the wheel via the tightening member.

(8) The non-pneumatic tire tire/wheel assembly described in any one of (1) to (7), wherein the tightening member is a cord-like member having pliability and self-tightening functionality.

(9) The non-pneumatic tire tire/wheel assembly described in any one of (1) to (7), wherein the tightening member is a core member having rigidity and pliability, and which exerts tightening functionality via a tightening fastener.

(10) The non-pneumatic tire tire/wheel assembly described in any one of (1) to (9), wherein the elastomer composition constituting at least a part of the tire main body is a thermoreversible crosslinking elastomer composition.

(11) The non-pneumatic tire tire/wheel assembly described in (10), wherein the thermoreversible crosslinking elastomer composition is a thermoreversible crosslinking elastomer composition comprising a side chain including a hydrogen-bonding crosslinking site having at least a carbonyl-containing group and a nitrogen-containing heterocycle or a side chain including a combination of said hydrogen-bonding crosslinking site and a covalent bonding crosslinking site.

(12) The non-pneumatic tire tire/wheel assembly described in (11), wherein the thermoreversible crosslinking elastomer composition includes a maleic acid modified olefin-based elastomer, a nitrogen-containing heterocycle compound, an olefin-based resin, a styrene-based elastomer, and a paraffin oil.

(13) The non-pneumatic tire tire/wheel assembly described in (12), wherein the nitrogen-containing heterocycle compound is a nitrogen-containing heterocycle polyfunctional alcohol, the olefin-based resin is polypropylene, and the styrene-based elastomer is a hydrogenated styrene-isoprene-butadiene block copolymer.

(14) The non-pneumatic tire tire/wheel assembly according to any one of (1) to (13), wherein the non-pneumatic tire tire/wheel assembly is a tire/wheel assembly for light vehicle use.

### Effect of the Technology

With the present technology according to (1), in a non-pneumatic tire tire/wheel assembly for light vehicle use or the like, a tire/wheel assembly is provided that is punctureless and in which the tire is strongly and reliably fixed to the wheel.

With the non-pneumatic tire tire/wheel assemblies of the present technology according to any one of (2) to (9), in addition to the effects obtained by the present technology according to (1), a tire/wheel assembly is provided whereby superior workability is obtained when tightening/fixing a tire main body to a wheel via a tightening member that is embedded in the tire main body throughout a circumferential direction thereof, and when releasing the tightened/fixed state of the tightening member.

With the non-pneumatic tire tire/wheel assemblies of the present technology according to any one of (10) to (13), in addition to the effects obtained by the present technology according to (1) to (9), because a thermoreversible crosslinking elastomer composition is used for the tire main body, it is easy to form the tire main body in a circular shape, the crosslinking can be released by applying heat, and it is possible to easily mold a non-pneumatic tire into a shape of a predetermined frame (rim) and fix it thereto by mating.

As a result, the work of assembling the tire main body on the wheel is facilitated and a tire/wheel assembly can be formed in which crosslinking has advanced by cooling the tire main body and wheel as-is. Moreover, the tire/wheel assembly is superior from the perspectives of ease of manufacture and low cost.

After assembling the tire/wheel assembly, the tire main body can be easily removed from the wheel by applying heat to the tightening member. Moreover, material recyclability of the main body of the non-pneumatic tire can be promoted by further extraction of the tightening member from the tire main body. In other words, the thermoreversible crosslinking elastomer composition can be molded into a new member without suffering a decline in physical properties due to melt processing. Thus, the thermoreversible crosslinking elastomer composition can be material recycled, leading to an enhancement in the recyclability of the tire/wheel assembly of the present technology.

With the technology according to (14), a tire/wheel assembly is provided that is optimal for use as a non-pneumatic tire for use on light vehicles such as bicycles, wheelchairs, golf carts, and the like that is punctureless, safer, and in which the tire main body does not separate from the rim.

### BRIEF DESCRIPTION OF THE DRAWINGS

FIG. 1 is a partial cross-sectional perspective view illustrating a relationship between a tire main body and a tightening member in order to describe a non-pneumatic tire tire/wheel assembly of the present technology.

FIG. 2-1 is a cross-sectional view in a tire meridian direction depicting an example of an embodiment of the non-pneumatic tire tire/wheel assembly of the present technology and depicts a cross-section at a position where a tightening member through-hole is not located.

FIG. 2-2 is a cross-sectional view in a tire meridian direction depicting an example of an embodiment of the non-pneumatic tire tire/wheel assembly of the present technology and depicts a cross-section at a position where a tightening member through-hole is not located.

FIG. 2-3 is a cross-sectional view in a tire meridian direction depicting an example of an embodiment of the non-pneumatic tire tire/wheel assembly of the present technology and depicts a cross-section at a position where a tightening member through-hole is located.

FIG. 2-4 is a cross-sectional view in a tire meridian direction depicting an example of an embodiment of the non-pneumatic tire tire/wheel assembly of the present technology and depicts a cross-section at a position where a tightening member through-hole is located.

FIG. 2-5 is a cross-sectional view in a tire meridian direction depicting an example of an embodiment of the non-pneumatic tire tire/wheel assembly of the present technology and depicts a cross-section at a position where a tightening member through-hole is located.

FIG. 3-1 is a main constituent cross-sectional view illustrating a vicinity of the tightening member through-hole in order to describe an example of an embodiment of the non-pneumatic tire tire/wheel assembly of the present technology.

FIG. 3-2 is a main constituent cross-sectional view illustrating a vicinity of the tightening member through-hole in order to describe an example of an embodiment of the non-pneumatic tire tire/wheel assembly of the present technology.

FIG. 4-1 is across-sectional side view describing an embodiment of the non-pneumatic tire tire/wheel assembly of the present technology.

FIG. 4-2 is a side view describing another embodiment of the non-pneumatic tire tire/wheel assembly of the present technology.

FIG. 4-3 is a main constituent cross-sectional side view describing another embodiment of the non-pneumatic tire tire/wheel assembly of the present technology.

FIG. 5-1 is a cross-sectional view in a tire meridian direction depicting an example of an embodiment of the non-pneumatic tire tire/wheel assembly of the present technology.

FIG. 5-2 is a cross-sectional view in a tire meridian direction depicting an example of an embodiment of the non-pneumatic tire tire/wheel assembly of the present technology.

FIG. 6-1 is a conceptual drawing describing a tightening fastener that can be used in the embodiments of the non-pneumatic tire tire/wheel assembly of the present technology.

FIG. 6-2 is a conceptual drawing describing a tightening fastener that can be used in the embodiments of the non-pneumatic tire tire/wheel assembly of the present technology.

FIG. 7-1 is a partial cross-sectional perspective view illustrating the structure of a conventional non-pneumatic tire tire/wheel assembly.

FIG. 7-2 is a cross-sectional view in a tire meridian direction illustrating the structure of a conventional non-pneumatic tire tire/wheel assembly.

### DETAILED DESCRIPTION

Hereinafter, a non-pneumatic tire tire/wheel assembly of the present technology is described in detail.

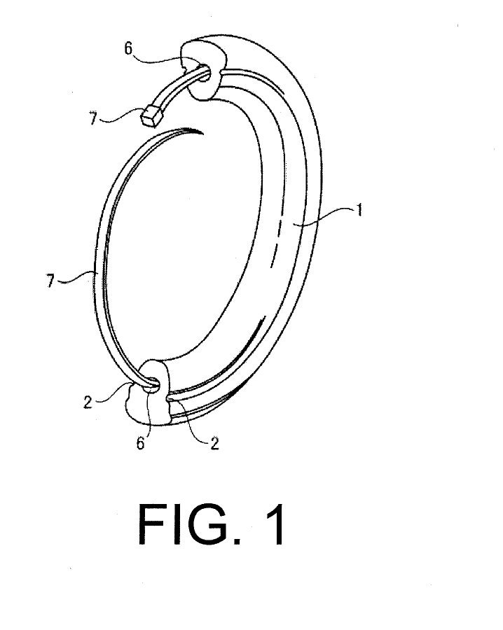

As illustrated in FIG. 1, a non-pneumatic tire tire/wheel assembly of the present technology includes a tire main body 1 at least a part of which is constituted by an elastomer composition, the tire main body 1 being assembled on a wheel 4 (not illustrated in FIG. 1). In the non-pneumatic tire tire/wheel assembly, the tire main body 1 is tightened to the wheel 4 by a tightening member 7 that is embedded in the tire main body 1 throughout a circumferential direction thereof. The fixing between the tire main body 1 and the wheel 4 is further strengthened by adding a tightening force provided by the tightening member 7 to a mating fixing force at groove portions 2.

As illustrated in the cross-sectional views of FIGS. 2-1 to 2-5, the tightening member 7 embedded in the tire main body 1 is disposed by being passed through an interior of a hollow hole 6 machined in the tire main body 1 in the tire circumferential direction. From the perspective of strength, a lateral cross-sectional shape of the hollow hole 6 is preferably round, as illustrated in FIGS. 1 and 2-1 to 2-5. However, the lateral cross-sectional shape is not particularly limited and may be square, polygonal such as triangular or the like, rectangular, elliptical, or the like having a suitable size in order to correspond with a material and/or lateral cross-sectional shape of the tightening member 7.

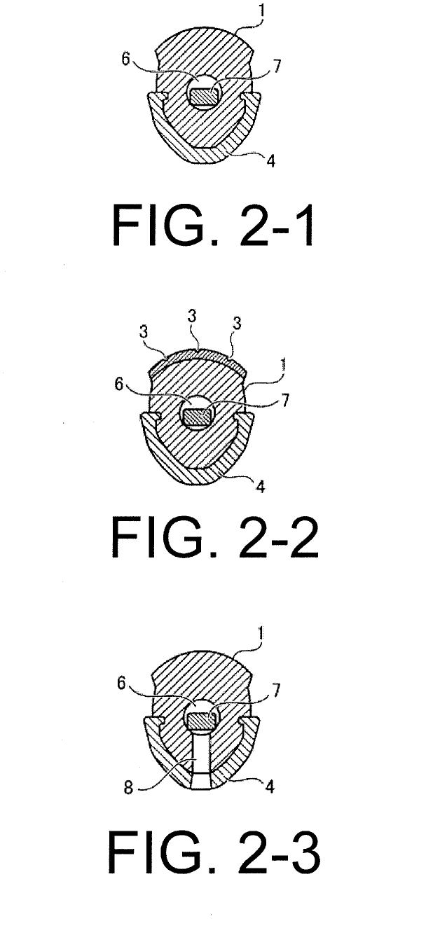

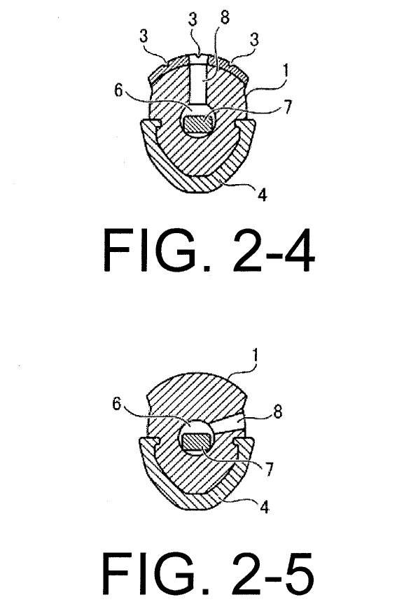

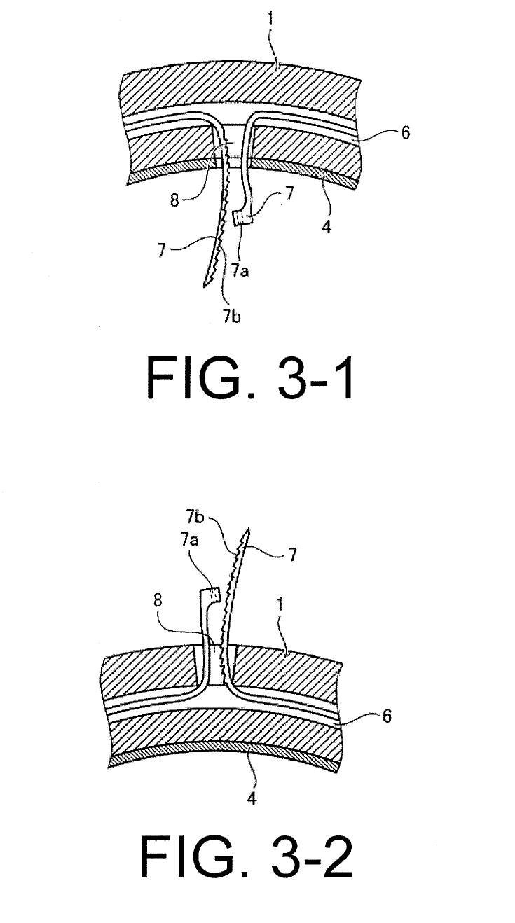

As illustrated in FIGS. 2-3 to 2-5, 3-1, and 3-2, both ends of the lightening member 7 are pulled out from within the tire main body 1 through a tightening member through-hole 8 communicating with the hollow hole 6 and opens to an outer surface of the tire main body 1; and are fastened using an appropriate fastening force so that the tire main body 1 can be sufficiently tightened and fixed to the wheel 4. Thus, in this tightened state, typically, the tightening member 7 embedded in the tire main body 1 is exposed at at least one location on a tire circumference and said exposed portions are fastened. FIG. 3-1 illustrates an example in which the tightening member through-hole 8 opens to a tire inner circumferential surface. In this case, the tightening member through-hole 8 is formed in both the tire main body 1 and the wheel 4. FIG. 3-2 illustrates an example in which the tightening member through-hole 8 opens to a tire outer circumferential surface. In this case, the tightening member through-hole 8 is formed only in the tire main body 1. Such a configuration is beneficial in that machining of the wheel 4 need not be performed.

It is sufficient that the tightening member through-hole 8 communicating with the hollow hole 6 described above be open to the outer surface of the tire main body 1. For example, the tightening member through-hole 8 may be open on the tire inner circumferential surface or, alternately, may be open on a tread surface or the like. Particularly, in these cases, the opening is preferably provided so that a tire equatorial plane crosses the opening surface, because such a configuration leads to the tightening force being effectively and stably exertable on the tire equatorial plane.

Alternatively, the position of the opening of the tightening member through-hole 8 may be provided so as to be positioned in the vicinity of a tire side surface or a shoulder portion of the tire. In cases where the opening of the tightening member through-hole 8 is provided positioned on the tire side surface, the opening of the tightening member through-hole 8 may be on a side surface on the inner circumferential surface side or, alternatively, on a side surface on the outer circumferential surface side. However, preferably, the opening of the tightening member through-hole 8 is provided on the side surface on the outer circumferential surface side because it will not be necessary to machine the wheel 4 and tightening work will be easy. Specifically, in cross-sectional views such as those illustrated in FIGS. 2-3, 2-4, and 2-5, from the perspectives of the workability of tightening and releasing, the tightening member through-hole 8 preferably opens more to the tread surface side than a center axis position of the hollow hole 6 in a tire radial direction.

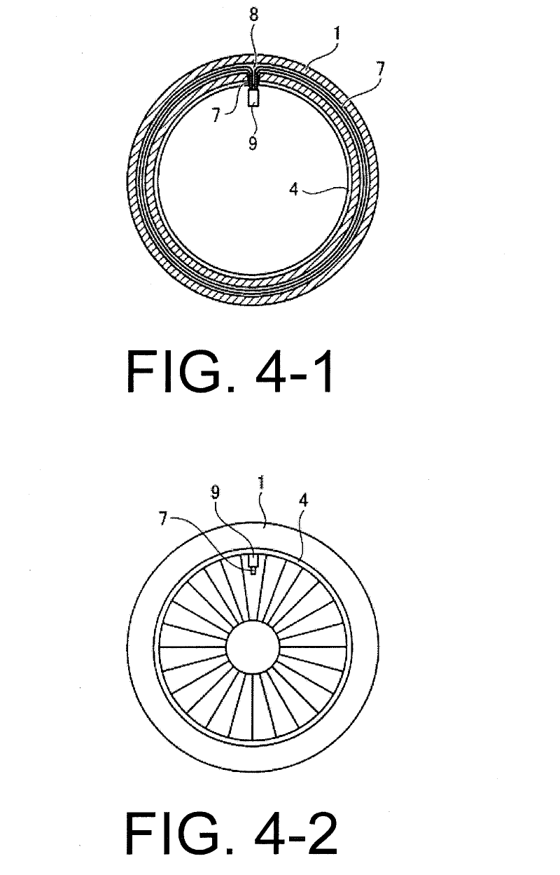

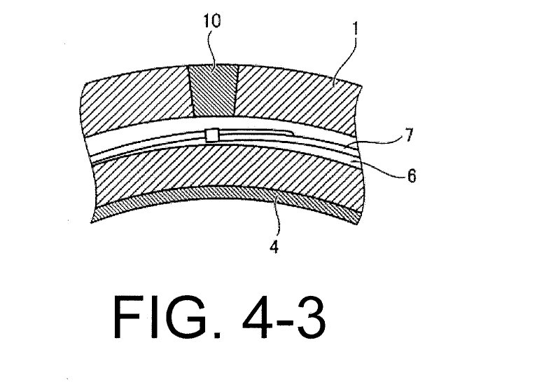

FIGS. 4-1, 4-2, and 4-3 are drawings that depict embodiments of the tightening. FIGS. 4-1 and 4-2 illustrate an embodiment in which the tire main body 1 is tightened on the wheel 4 by pulling the tightening member 7 through the tightening member through-hole 8 on the inner circumferential surface side of tire main body 1 and using a tightening fastener 9. Additionally, as, illustrated in FIG. 4-3, the fastened portion of the tightening member 7 may be pressed back into the hollow hole 6 of the tire main body 1 after tightening to a desired degree is performed using the tightening member 7. Furthermore, the tightening member through-hole 8 may be sealed by filling with a tightening member through-hole filler material 10 including a thermoplastic elastomer composition or a thermoreversible crosslinking elastomer composition, so that tightening member 7 is not exposed on the outer surface of the tire main body 1.

By forming a structure in which the tightening member through-hole 8 is sealed by the tightening member through-hole filler material 10 as illustrated in FIG. 4-3, the entire circumference of the tire can be fixed via a uniform tightening force and the problem of durability declining due to the hole that was actually opened in the outer surface of the tire main body 1 will not occur. Additionally, because the tightening fastened portion is not exposed on the outer surface of the tire, the tightening fastened portion will not be subjected to being damaged by external forces and the like, and a durable, reliable tightening/fixing can be achieved.

The tightening member 7 need not be provided throughout the entire circumference of the tire and, for example, may be provided in only a portion in the circumferential direction for the purpose of reducing overall weight. This is because it is sufficient that the tightening/fixing of the tire main body 1 to the wheel 4 be exerted to exactly the level necessary to achieve the expected purpose.

Examples of commercially available products that can be preferably used as the tightening member 7 include cable ties such as those marketed under the trade name Ty-Rap and the like. Generally, the tightening member 7 is made from a cord-like synthetic resin having pliability. For example, as illustrated in FIGS. 3-1 and 3-2, the tightening member 7 has a configuration in which: a first end portion of the tightening member 7 has a locking portion 7a and a second end portion has a toothed portion 7b, the end portions are bound by passing the toothed portion 7b through the locking portion 7a, the tightening force can be increased by pulling on the toothed portion 7b, and the end portions do not retract. Such a tightening member 7 formed from a synthetic resin cord-like member or the like having self-tightening functionality can be preferably used in the present technology because overall weight is light and workability is excellent.

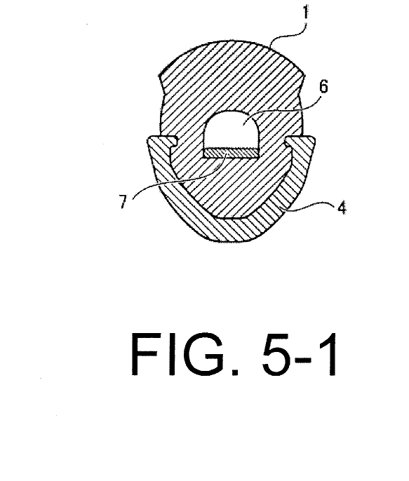

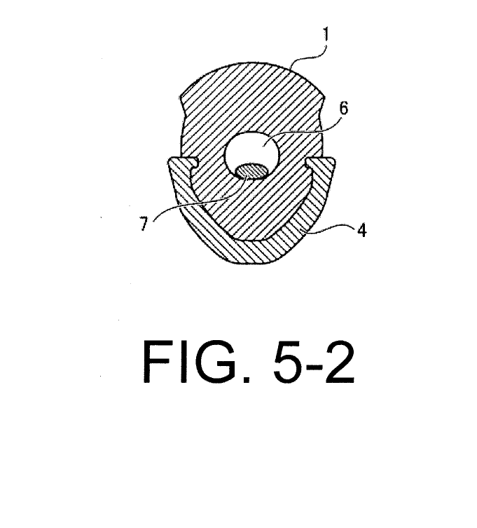

Additionally, as illustrated in FIGS. 5-1 and 5-2, the lateral cross-sectional shape of the tightening member 7 and the lateral cross-sectional shape of the hollow hole 6 are preferably formed such that contact surfaces thereof have the same cross-sectional shapes so that contact occurs on a wider surface at portions where the constituents contact each other. FIG. 5-1 is an example in which a tightening member 7 having a rectangular lateral cross-section contacts a bottom surface of a hollow hole 6 having an inverted “U” shape lateral cross-section in order to carry out the tightening/fixing. FIG. 5-2 is an example in which tightening/fixing is performed where both the bottom of the hollow hole 6 and the tightening member 7 are formed so that the contacting curved surfaces (bottom surfaces) of both constituents are elliptical. Tightening/fastening is performed where the contact surfaces of the tightening member 7 and the hollow hole 6 are provided with the same cross-sectional shape so as to be in contact with each other over a wide area. Therefore, the tightening member 7 will not easily twist or meander, and stress applied to each other can be dispersed. As a result, the tire main body 1 and the rim will be even less prone to separation and durability will be superior.

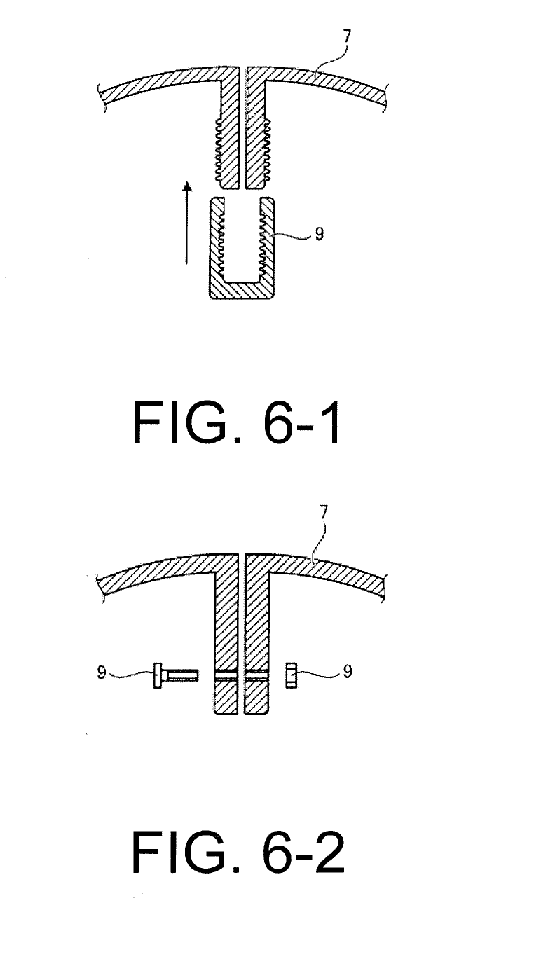

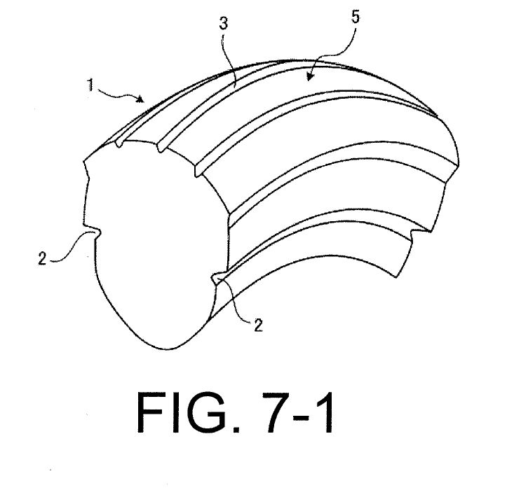

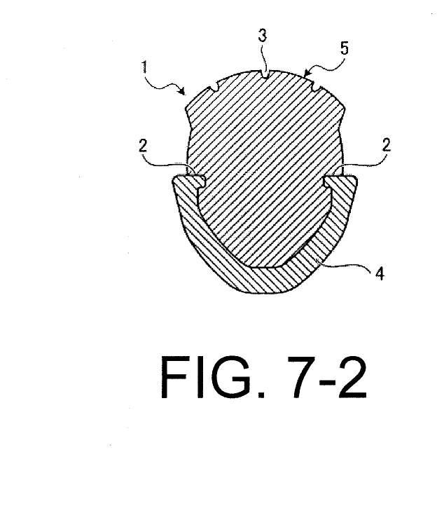

The tightening member 7 preferably has an appropriate amount of rigidity and pliability throughout. For example, the tightening member 7 may include a core material formed from a metal rod-like object or cord-like object made of steel or the like. In such a case, as illustrated in FIGS. 6-1 and 6-2, tightening is preferably carried out using a tightening fastener 9 that can be tightened by a screw mechanism or the like. The tightening fastener 9 illustrated in FIG. 6-1 is an example where tightening/fixing is carried out using a cover screw-type tightening fastener. The tightening fastener 9 illustrated in FIG. 6-2 is an example where tightening/fixing is performed using a tightening fastener 9 consisting of a bolt and nut pair.

In the present technology, the elastomer composition constituting the tire main body is preferably a thermoreversible crosslinking elastomer composition. By using this thermoreversible crosslinking elastomer composition for the tire main body, the molding workability when fabricating described above, an enhancement in material recyclability, and the like can be achieved.

From the perspective of obtaining excellent thermoreversible crosslinking, the thermoreversible crosslinking elastomer composition is preferably a thermoreversible crosslinking elastomer composition comprising a side chain including a hydrogen-bonding crosslinking site having at least a carbonyl-containing group and a nitrogen-containing heterocycle or a side chain including a combination of said hydrogen-bonding crosslinking site and a covalent bonding crosslinking site.

In the hydrogen-bonding crosslinking site having the carbonyl-containing group and the nitrogen-containing heterocycle, the carbonyl groups in the carbonyl-containing group and the amino groups in the nitrogen-containing heterocycle form hydrogen bonds. The nitrogen-containing heterocycle may be compounded by adding a nitrogen-containing heterocycle-containing compound as a crosslinking agent. Examples of carbonyl compounds that constitute the hydrogen-bonding crosslinking site include carbonyl groups, carboxyl groups, amide groups, ester groups, and imide groups.

The thermoreversible crosslinking elastomer composition preferably includes a maleic acid modified olefin-based elastomer, a nitrogen-containing heterocycle compound, an olefin-based resin, a styrene-based elastomer, and a paraffin oil. By configuring the thermoreversible crosslinking elastomer composition as described above, the composition will have excellent physical properties, high fluidity, and excellent formability.

A preferable composition of the thermoreversible crosslinking elastomer composition includes the maleic acid modified olefin-based elastomer and, per 100 parts by mass thereof, not less than 0.1 parts by mass and not more than 3.0 parts by mass of the nitrogen-containing heterocycle compound, not less than 50 parts by mass and not more than 150 parts by mass of the olefin-based resin, not less than 20 parts by mass and not more than 80 parts by mass of the styrene-based elastomer, and not less than 50 parts by mass and not more than 150 parts by mass of the paraffin oil. Additionally, preferably, the nitrogen-containing heterocycle compound is a nitrogen-containing heterocycle polyfunctional alcohol, the olefin-based resin is polypropylene, and the styrene-based elastomer is a hydrogenated styrene-isoprene-butadiene block copolymer.

The thermoreversible crosslinking elastomer composition is preferably used for the tire main body because it will be easy to form the tire main body so as to be circular, the crosslinking can be released by applying heat, and it will be possible to easily mold a non-pneumatic tire into a shape of a predetermined frame (rim) and fix it thereto by mating.

Additionally, cases where the tightening member through-hole 8 is filled with a resin or the like are preferable, provided that the filling is performed using a filler material including the thermoplastic elastomer composition or the thermoreversible crosslinking elastomer composition, because the filler material can be plasticized or, alternately, the crosslinking can be released by applying heat, and the filling work and removing work can be performed easily. Particularly, it is preferable that the tire main body is formed using the thermoreversible crosslinking elastomer composition and that the tightening member through-hole filler material 10 is also formed using the thermoreversible crosslinking elastomer composition, because both constituents (the tire main body 1 and the tightening member through-hole filler material 10) can be treated the same when applying heat to release the tightened state.

The non-pneumatic tire tire/wheel assembly of the present technology is effective when used as a non-pneumatic tire for light vehicle use on a variety of light vehicles such as bicycles, wheelchairs, golf carts, trailers towed by bicycles, and the like for which normal usage conditions are those such as being under a comparatively light load, traveling at low speeds, and the like.

The non-pneumatic tire tire/wheel assembly of the present technology is manufactured by, first, performing extrusion molding using an elastomer composition pellet to form a hollow tire main body portion. The obtained tire main body portion is shaped so as to be circular, and end portions are abutted against each other and joined by melt bonding at a high temperature. Thus, the circular shape is formed. Thereafter, the tightening member through-hole 8 is machined. When assembling on the rim, in addition to fixing the tire on the rim using the groove portions 2, the tightening member 7 is passed through the hollow hole 6 and the exposed portions of both ends thereof are fastened and tightened. Thus, the non-pneumatic tire tire/wheel assembly of the present technology is manufactured.

As illustrated in FIGS. 4-1 and 4-2, the fastened portion of the tightening member, along with the tightening fastener, is configured so as to be on the tire inner circumferential surface side in a state of appropriate protrusion from the outer side thereof; or, alternately, the fastened portion is pressed back into the hollow hole in the tire main body and stored and, optionally, the tightening member through-hole 8 is sealed by filling with the filler material including the thermoplastic elastomer composition or the thermoreversible crosslinking elastomer composition.

What is claimed is:

1. A non-pneumatic tire tire/wheel assembly comprising a tire main body at least a part of which is constituted by an elastomer composition, the tire main body being assembled on a wheel, wherein the tire main body is tightened and fixed to the wheel by a tightening member that is embedded in the tire main body throughout a tire circumferential direction within a machined hollow hole, and wherein
the tightening member embedded in the tire main body is exposed at at least one location on a tire circumference via the tightening member through-hole communicating with the hollow hole, open to the outer surface of the tire main body and provided in the tire main body, and both end portions of the tightening member are fastened at the exposed portion, and
the tightening member which is a cord-like member having pliability has a locking portion on the first end portion and a toothed portion on the second end portion, and the end portions are bound to tighten by passing the toothed portion through the locking portion.

2. (canceled)

3. (canceled)

4. The non-pneumatic tire tire/wheel assembly according to claim 1, wherein the tightening member through-hole communicating with the hollow hole opens more to a tread surface side than a center axis position of the hollow hole in a tire radial direction.

5. The non-pneumatic tire tire/wheel assembly according to claim 4, wherein the tightening member through-hole communicating with the hollow hole opens to a tread surface.

6. The non-pneumatic tire tire/wheel assembly according to claim 5, wherein the tightening member through-hole is disposed at a location where the opening overlaps with a tire equatorial plane, and opens to the tread surface.

7. The non-pneumatic tire tire/wheel assembly according to claim 6, wherein the tightening member through-hole is filled with a thermoplastic elastomer composition or a thermoreversible crosslinking elastomer composition after the tire main body is tightened and fixed to the wheel via the tightening member.

8. (canceled)

9. (canceled)

10. The non-pneumatic tire tire/wheel assembly according to claim 9, wherein the elastomer composition constituting at least a part of the tire main body is a thermoreversible crosslinking elastomer composition.

11. The non-pneumatic tire tire/wheel assembly according to claim 10, wherein the thermoreversible crosslinking elastomer composition is a thermoreversible crosslinking elastomer composition comprising a side chain including a hydrogen-bonding crosslinking site having at least a carbonyl-containing group and a nitrogen-containing heterocycle, or a side chain including a combination of said hydrogen-bonding crosslinking site and a covalent bonding crosslinking site.

12. The non-pneumatic tire tire/wheel assembly according to claim 11, wherein the thermoreversible crosslinking elastomer composition comprises a maleic acid modified olefin-based elastomer, a nitrogen-containing heterocycle compound, an olefin-based resin, a styrene-based elastomer, and a paraffin oil.

13. The non-pneumatic tire tire/wheel assembly according to claim 12, wherein the nitrogen-containing heterocycle compound is a nitrogen-containing heterocycle polyfunctional alcohol, the olefin-based resin is polypropylene, and the styrene-based elastomer is a hydrogenated styrene-isoprene-butadiene block copolymer.

14. The non-pneumatic tire tire/wheel assembly according to claim 13, wherein the non-pneumatic tire tire/wheel assembly is a tire/wheel assembly for light vehicle use.

15. The non-pneumatic tire tire/wheel assembly according to claim 1, wherein the tightening member through-hole which communicates with the hollow hole opens to a tire inner circumferential surface.
